(19) United States
(12) Patent Application Publication
(10) Pub. No.: US 2012/0175380 A1
(43) Pub. Date: Jul. 12, 2012

(54) AUTOMATIC MEDICATION DISPENSING DEVICE

(75) Inventors: Takumi Nishimura, Ehime (JP); Naoshi Kainoh, Ehime (JP); Tadashi Ogino, Yamanashi (JP); Naoki Kitta, Yamanashi (JP); Yasuyuki Maeda, Ehime (JP); Michimori Nakano, Ehime (JP)

(73) Assignee: PANASONIC CORPORATION, Osaka (JP)

(21) Appl. No.: 13/383,559

(22) PCT Filed: Jul. 13, 2010
(86) PCT No.: PCT/JP2010/004543

§ 371 Date: Mar. 23, 2012

(30) Foreign Application Priority Data
Jul. 14, 2009 (JP) 2009-165287

(51) Int. Cl. G07F 11/00

(52) U.S. Cl. 221/12; 221/9

(57) ABSTRACT

An automatic medication dispensing device 101 of the present invention includes supplying means which supplies an accommodated medication based on a prescription instruction, the supplying means includes a head body section 401a, a pocket section 404 which temporarily holds a taken out medication and places the medication on the tray, and an arm section 405 which couples the head body section and the pocket section to each other, the pocket section 404 is turnably connected to one end of the arm section 405 through a first shaft 406, and the other end of the arm section 405 and the head body section 401a are turnably connected to each other through a second shaft 407. Therefore, it is possible to provide an automatic medication dispensing device in which an occupied space, especially a depth dimension of the device is reduced, and the device can prevent a medication ample from being damaged.

### TECHNICAL FIELD

The present invention relates to an automatic medication dispensing device which dispenses a medicine based on a prescription instruction in a hospital or the like.

### BACKGROUND TECHNIQUE

An automatic medication dispensing device automatically dispenses a medicine in accordance with a prescription to a tray which is prepared for each patient. The automatic medication dispensing device is provided with a medication supplying unit which stores medicines in an accommodating section, and which dispenses the medicine based on a prescription instruction. The medication supplying unit is provided with supplying means which takes out a desired medicine from the accommodating section, and dispenses the medicine to a tray, and supplying means having various ingenuities have been disclosed in the past (patent document 1 and patent document 2).

### PRIOR ART DOCUMENTS

### Patent Documents

[Patent Document 1] Japanese Patent Application Laid-open No. 2007-209599
[Patent Document 2] Japanese Patent Application Laid-open No. 2003-81429

### SUMMARY OF THE INVENTION

### Problem to be Solved by the Invention

However, the automatic medication dispensing device inevitably becomes large in size and a large installation space is required because it is necessary to accommodates a large number of medicines and the device requires places where vacant trays as many as the number of patients are prepared and stored and where trays to which medicines are dispensed are accommodated. Further, if various functions are added, a depth dimension of the device is increased and this is a cause of increase in the installation space. Especially in a medium-scale hospital having about 200 to 400 beds, the automatic medication dispensing device exerts effect if the automatic medication dispensing device is introduced, but there is a problem that the device can not be introduced clue to the installation space. Hence, an automatic medication dispensing device requiring a small installation space is desired.

The automatic medication dispensing device also dispenses a medicine which is accommodated in an easily breakable container and which must be handled with the greatest care such as an injection ampule and an instilment bag. In the automatic medication dispensing device, one of procedures in which a medicine container is prone to be damaged is a step of taking out a medicine to a step of supplying the medicine to a tray. Therefore, it is desired to realize supplying means which does not easily damage a medicine.

Hence, it is an object of the present invention to provide an automatic medication dispensing device requiring a small installation space especially a small depth dimension. In addition, it is an object of the invention to provide an automatic medication dispensing device having supplying means which does not easily damage a medicine container.

### Means for Solving the Problem

According to an invention described in claim 1, there is provided an automatic medication dispensing device having supplying means which supplies accommodated medications to a tray based on the prescription instruction, wherein the supplying means includes a head body section, a pocket section which temporarily holds a taken out medication and which places the medication on the tray, and an arm section which couples the head body section and the pocket section to each other, the pocket section is turnably connected to one end of the arm section through a first shaft, and the other end of the arm section and the head body section are turnably connected to each other through a second shaft.

Here, it is only necessary that the “pocket section” can temporarily hold a taken out medicine and its shape is not limited. It is only necessary that the “arm section” can connect the head body and the pocket section with each other, its shape is not limited and the arm section need not be of a plate-shape or a rod-shape.

According to an invention described in claim 2, in the automatic medication dispensing device of claim 1, an abutment section is provided at a position of the head body section closer to the tray that the first shaft, the pocket section is provided with a guide section, the guide section abuts against the abutment section and in this state, the pocket section places a medication on the tray.

According to an invention described in claim 3, in the automatic medication dispensing device of claim 2, the guide section includes a first guide surface and a second guide surface which is continuous with the first guide surface and which has a curvature or an angle different from that of the first guide surface.

According to an invention described in claim 4, in the automatic medication dispensing device of claim 1, 2 or 3, the device comprises tray conveying means which conveys the tray, the tray conveying means includes moving means which moves the tray toward the pocket section when a medication is placed on the tray.

According to an invention described in claim 5, in the automatic medication dispensing device of claim 1, 2 or 3, the device further comprises tray conveying means which conveys the tray, the tray conveying means includes turning means which rotates the tray in a horizontal direction.

According to an invention described in claim 6, there is provided an automatic meditation dispensing device including supplying means which temporarily holds medications accommodated in a medication storing case and then dispenses the medication to a tray based on a prescription instruction, wherein the automatic medication dispensing device includes a flap provided at a position where the flap comes into contact with the medication when the medication is taken out from the medication storing case to the supplying means.

Here, the “flap” is a cloth body or a plate body whose one end is connected to the supplying means, and it is necessary that the flap can move in a direction in which a medicine moves when the medicine is taken out from the medication storing case to the supplying means.

According to an invention described in claim 7, in the automatic medication dispensing device of claim 6, when the medication in the medication storing case is taken out to the supplying means based on a prescription instruction, the medication is temporarily stopped by the flap, and after the medication is temporarily stopped, the flap is moved, thereby releasing engagement between the medication and the flap to drop the meditation into the supplying means.

According to an invention described in claim 8, in the automatic medication dispensing device of claim 7, the device further comprises holding means which holds the flap at a position where the medication is temporarily stopped and a position where engagement with respect to the medication is released when the medication in the medication storing case is taken out to the supplying means.

According to an invention described in claim 9, in the automatic medication dispensing device of claim 7 or 8, the device further comprises a movable section at a path where the medication is taken out from the medication storing case, an inclination angle of the movable section is changed in an interlocking manner with movement of the flap.

### Effect of the Invention

According to the invention described in claim 1, since the automatic medication dispensing device includes the arm section, when a medication is placed on the tray, i.e., when a medication is dispensed, the pocket section can be moved toward a tray located more forward. That is, it is unnecessary to move the tray toward the head body section, or even if the tray is moved, its moving distance can be shortened, depth dimension of the automatic meditation dispensing device can be shortened, and it is possible to realize an automatic medication dispensing device requiring a small installation area. Since the automatic medication dispensing device has the arm section, it is possible to supply a medication from a location lower than that of the conventional technique, it is possible to supply a medication to the tray by a method having a smaller impact, and it is possible to prevent a medication from being damaged.

According to the invention described in claim 2 the guide section and the abutment section are provided. According to this, it is possible to move the pocket section toward a tray located more forward than the abutment section, and to dispense a medication to the tray. That is, is unnecessary to move the tray toward the head body section, or even if the tray is moved, its moving distance can be shortened, depth dimension of the automatic medication dispensing device can be shortened, and it is possible to realize an automatic medication dispensing device requiring a small installation area. Further, since the abutment section is provided at the position in front of the first shaft, it is possible to reduce the angle of the bottom surface of the pocket section with respect to the tray when a medication is to be dispensed, and even if a medication is accommodated in a breakable medication container, the medication can be moved to the tray slowly, and it is possible to realize supplying means having less possibility of damage of the medication container.

According to the invention described in claim 3, since the guide section is provided a guide surface having a plurality of curvatures or angles, operation of the pocket section can be changed. For example, the pocket section is first moved to a location directly above the tray and then, a medication is moved to the tray at a gentle angle between the bottom surface of the pocket section and a bottom surface of the tray, and medications can reliably be transferred to the trays without allowing medications to remain in the pocket section while increasing the angle.

According to the invention described in claim 4, since the tray can be moved toward the head body section, the pocket section and the tray come close to each other and hence, it is possible to dispense a medication more swiftly. The moving distance to the tray toward the depth dimension can be shortened by moving the pocket section toward the forward tray. Therefore, it is possible to shorten the depth dimension of the automatic medication dispensing device, and it is possible to realize an automatic medication dispensing device requiring a small installation area.

According to the invention described in claim 5, since the tray can be rotated, even when a medication is to be placed on a region of the tray farthest away from the pocket section, the medication can be placed on the tray by rotating the tray without moving the tray by the moving means. According to this, since the moving distance of the tray in the depth dimension direction can be shortened, the depth dimension of the automatic medication dispensing device can be shortened, and it is possible to realize an automatic medication dispensing device requiring a small installation area.

According to the invention described in claim 6, when a medication is taken out so that the medication is temporarily held by the supplying means, the medication comes into contact with the flap and the flap is jumped up in a direction in which a barycenter of the flap becomes high and according to this, the speed of the medication can be reduced. Therefore, when a plurality of medications is taken out into the supplying means, it is possible to avoid a case where the medications collide against each other and the medications are damaged.

Further, if material, shape, size of the flap and a coupling method with respect to the supplying means are appropriately adjusted in accordance with weight and shape of medications, the taken out medication comes into contact with the flap and the speed of the medication can sufficiently be reduced, and it is possible to open the flap by the weight of the medication its own, and to reliably drop the medication into the supplying means.

According to the invention described in claim 7, a medication is temporarily stopped by the flap and the speed of the medication can be brought into zero. After the speed of the medication taken out from the medication storing case is brought into zero, the engagement between the flap and the medication is released and the medication is made to drop into the supplying means. Therefore, the speed of the medication dropping into the supplying means does not correspond to a position of the medication storing case but corresponds to a position where the medication is temporarily stopped. According to this, the height from the supplying means can be lowered and the speed of the medication dropping into the supplying means can be reduced and thus, it is possible to prevent the medication from being damaged.

After the medication is temporarily stopped by the flap, the engagement with respect to the flap is released and the medication is made to drop into the supplying means. Hence, in the dispensing operation of the medication, it is possible to reliably avoid such an error that a taken out medication can not open the flap by its own weight and does not drop into the supplying means and the medication is not dispensed, and such an error that a medication which did not drop is dispensed when another medication for other patient is dispensed.

According to the invention described in claim 8, the flap can be held at a predetermined position by the holding means. Hence, it is possible to release the engagement between a medication and the flap and to reliably drop the medication into the supplying means by reliably and temporarily stopping the medication and releasing the flap-holding state by the holding means.

According to the invention described in claim 9, a medication is temporarily stopped by the flap and the movable section whose inclination angle is changed in the interlocking manner with the movement of the flap, and the speed of the medication taken out into the supplying means can sufficiently be reduced. Therefore, even when a plurality of medications are to be taken out into the supplying means, it is possible to avoid a case where the medications collide against each other and the medications are damaged.

### BRIEF DESCRIPTION OF THE DRAWINGS

FIG. 1 is a front view of an automatic medication dispensing device of the present invention;

FIG. 2 is a perspective view of an outward appearance of a tray conveying unit of the device;

FIG. 3 is a configuration diagram of an essential portion of the tray conveying unit of the device;

FIG. 4 is a side view of an interior of a medication supplying unit of the device;

FIG. 5 is a perspective view of an outward appearance of supplying means of a first embodiment of the device;

FIG. 6 is a side view of the supplying means of the first embodiment of the device;

FIG. 7 are explanatory diagrams showing movements of a pocket section configuring the supplying means of the first embodiment of the device;

FIG. 8 are explanatory diagrams showing movements of a tray of the device;

FIG. 9 is a side view of supplying means of a second embodiment of the device;

FIG. 10 are schematic diagrams showing, in stages, medication taking out movements when a medication supplying unit does not have a flap;

FIG. 11 are schematic diagrams showing, in stages, medicine taking out movements of a third embodiment of the device;

FIG. 12 is a side view showing a state where one of side surfaces is removed for explaining an interior structure of a medication supplying unit of a automatic medication dispensing device of the third embodiment of the device;

FIG. 13 are schematic diagram showing, in stages, medication taking out movements of a fourth embodiment of the device;

FIG. 14 is a side view showing a state where one of side surfaces is removed for explaining an interior structure of a medication supplying unit of a fourth embodiment of the device;

FIG. 15 are schematic diagram showing, in stages, medication taking out movements of a fifth embodiment of the device; and

FIG. 16 are schematic diagram showing, in stages, medication taking out movements of supplying means of a conventional automatic medication dispensing device.

### EXPLANATION OF SYMBOLS

101 automatic medication dispensing device
102 non-accommodated tray unit
103 medication supplying unit
104 printer unit
105 accommodated tray unit
106 tray conveying means
107 tray
201 first conveyor
202 second conveyor
203 third conveyor
401, 901 head
401a head body
403 medication storing case
404, 904 pocket
405, 905 arm
406, 906 first shaft
407, 907 second shaft
408 guide
409 rollers
410 chute
411 flap
412 hinge
413 movable section
500 medication

### MODE FOR CARRYING OUT THE INVENTION

(1, Automatic Medication Dispensing Device)

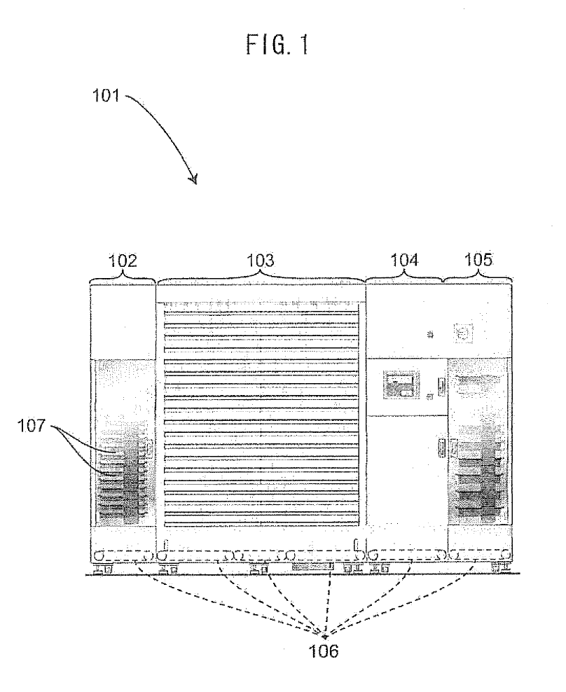

Concerning an exemplary example of the present invention, a structure of an entire automatic medication dispensing device of the present invention having supplying means which supplies an accommodated medication to a tray based on a prescription instruction will be described with reference to FIG. 1.

FIG. 1 is a front view of an outward appearance of an automatic medication dispensing device 101. The automatic medication dispensing device 101 includes a non-accommodated tray unit 102, a medication supplying unit 103, a printer unit 104, an accommodated tray unit 105 and tray conveying means 106 which connect these units to one another.

The non-accommodated tray unit 102 loads and accommodates vacant trays 107 on which various medications are placed, and supplies vacant trays to the tray conveying means 106. In this embodiment, the vacant tray accommodating unit 102 is provided at its front surface with a door made of clear plastic or glass so that stock of trays can be checked, but this cover is not absolutely required and the trays 107 may be loaded and accommodated such that the trays are exposed.

The medication supplying unit 103 stores various kinds of medications in a fractionation manner, and supplies and places a medication which is necessary for each patient to and on a vacant tray 107 conveyed from the non-accommodated tray unit 102 by the tray conveying means 106 based on a prescription instruction such as prescription data. The medication supplying unit includes a large number of medication cases in which medications are stored by kinds, and supplying means which takes out a desired medication from the medication case based on the prescription instruction by placing the medication on the tray. Details thereof will be described later. It is only necessary that medications are to be prescribed, and examples of the medications are injection drug, drops, internal medicine, medical plaster, suppository and the like. Typical packages of medications themselves are an ampule and a plastic bottom in the case of injection drug, a transfusion bag in the case of the drops, and a small bottle or a SP packet in the case of internal use tablet or powdered medicine.

The printer unit 104 includes a printer for printing a prescription on which contents of medicine prescription such as an injection label or printing medication labels of various kinds of medicines are described. The printer unit 104 supplies and places the printed prescription and a medication label to and on a tray 107 conveyed from the medication supplying unit 103 by the tray conveying means 106. In this embodiment, a front surface of the printer unit is covered with an opaque metal or plastic door to prevent dust and foreign matter from entering from outside and the door can be opened and closed. Individual information is described on a printed matter printed by the printer, and confidentiality thereof is high. Hence, individual certification means may be provided and the door may be opened and closed. Positions of the medication supplying unit 103 and the printer unit 104 may be reversed.

The accommodated tray unit 105 receives, loads and accommodates a tray 107 conveyed from the printer unit 104 by the tray conveying means 106. At this point, various kinds of medications, injection labels and medication labels are placed on the trays 107. Like the non-accommodated tray unit 102, the accommodated tray unit 105 is also provided at its front surface with a door made of clear plastic or glass so that accommodated strays can be checked. According to this configuration, it is possible to prevent a tray 107 on which a medicine is placed from being destroyed and to prevent the medicine from being damaged. However, these covers are not absolutely required in terms of function, and the trays 107 may be placed and accommodated such that they are exposed. A tray 107 plated on the accommodated tray unit 105 is transferred to a cart or the like, and conveyed to a doctor or a patient by a nurse or a pharmacist.

The tray conveying means 106 connect the non-accommodated tray unit 102 to the accommodated tray unit 105 through the medication Supplying unit 103 and the printer unit 104 by means such as belt conveyers. According to this embodiment, the tray conveying means 106 are independently provided on lower portion of these units. The tray conveying means receives a vacant tray 107 from the non-accommodated tray unit 102, the tray conveying means receives a medication from the medication supplying unit 103, the tray conveying means receives a prescription and a medication label from the printer unit 104 onto the tray 107, and the tray 107 on which the medicine and the prescription are placed is delivered to the accommodated tray unit 105. By providing these tray conveying means 106 on a line, trays can be disposed, medications can be supplied, printed matters can be supplied, and trays can be delivered by each unit simultaneously in parallel, and it is possible to realize more swift dispensation. Detailed configuration and movements of the tray transferring means 106 will be described later.

(2, Tray Conveying Means)

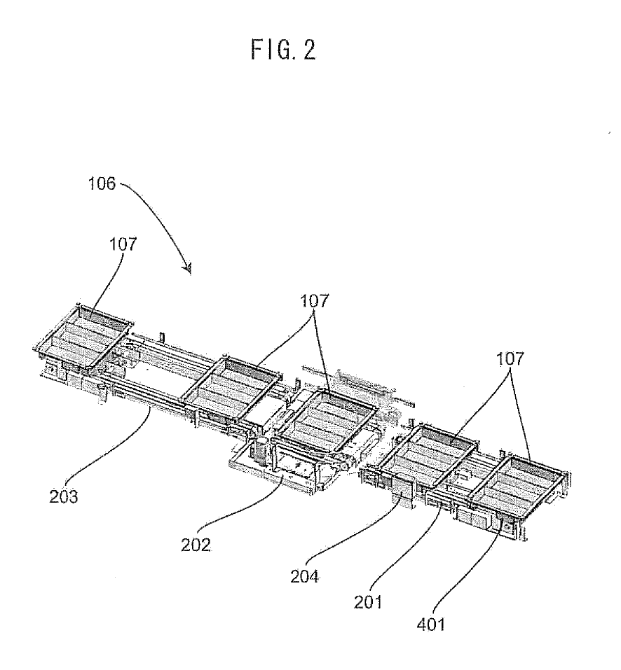

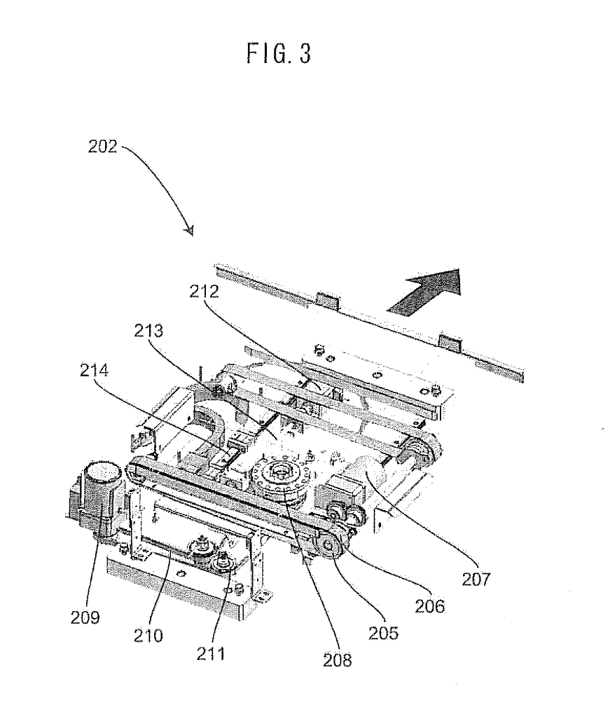

A configuration of the tray conveying means will be described using FIGS. 2 and 3. FIG. 2 is a perspective view of an outward appearance of the tray conveying means of a lower portion of the medication supplying unit. FIG. 3 is a configuration diagram of a second conveyor of the tray conveying means which can turn. Although FIGS. 2 and 3 show a configuration when trays are conveyed from right to left, but the trays may be conveyed from left to right depending upon a space of a hospital.

The tray conveying means 106 located at a lower portion of the medication supplying unit 103 includes a combination of a plurality of belt conveyors. That is, the tray conveying means 106 includes a first conveyor 201, a second conveyor 202 and a third conveyor 203.

The first conveyor 201 includes rollers, a belt and a motor for driving the rollers, the first conveyor 201 receives a command from a control device such as a computer (not shown) to drive the motor, and conveys trays. The first conveyor 201 is located upstream of the medication supplying unit 103, receives a tray 107 which flows from a side of the non-accommodated tray unit 102, and delivers the tray to the second conveyor 202. When trays 107 stagnate on the second conveyor 202, it is possible to control such that the trays 107 wait on the first conveyor 201.

An electronic card writing device 204 is provided at an intermediate portion of the first conveyor 201, patient information such as date, name of patient, hospital ward, hospital room and patient ID is written on an electronic card 401 which is a patient card provided on a side surface of a tray 107, and the information is displayed by display means on the electronic card. Information such as contents of prescription and kinds of prescribed medicine may be written at the same time. The electronic card writing device 204 may be provided on the third conveyor 203 or the tray conveying means 106 of a lower portion of the printer unit 104. The second conveyor 202 is located between the first conveyor 201 and the third conveyor 203, receives a tray from the first conveyor 201, and delivers the tray to the third conveyor 203. The second conveyor 202 corresponds to moving means and turning means. The second conveyor 202 itself moves in a direction perpendicular to a conveying direction of a tray, or the second conveyor 202 itself turns. The supplying means is provided on the second conveyor, and the supplying means dispenses a medication to a region of a desired tray by combining the moving means and the turning means.

A detailed configuration of the second conveyor 202 will be described using FIG. 3. The second conveyor 202 functions as the moving means which moves a tray toward the supplying means, and as the turning means which rotates a tray. The moving means and the turning means are not limited to the following means only if they can move a tray in a direction perpendicular to the conveying direction or can rotate a tray.

The second conveyor 202 includes rollers 205, belts 206 and a motor 207. A driving force of the motor 207 is transmitted to the rollers 205, the endless belts 206 are rotated, thereby conveying a tray 107 on upper ends of the belts 206. The second conveyor 202 also includes a turning section 200, a motor 209, a belt 210 and rollers 211. A driving force of the motor 209 is transmitted to the turning section 208 through the belt 210 and the rollers 211, the turning section 208 turns, thereby rotating the entire second conveyor 202 in the horizontal direction together with a tray placed on the upper portion. The second conveyor 202 is provided with a motor 212, a ball screw 213, and a rail member 214. A driving force of the motor 212 is transmitted to the ball screw 213, rotation movement of the motor 212 is converted into straight movement, and the entire second conveyor 202 can more in a direction (direction of arrow in FIG. 3) perpendicular to a conveying path of a tray extending from the first conveyor 201 to the third conveyor 203.

Like the first conveyor 201, the third conveyor 203 also includes rollers, belts and a motor for driving the rollers, the third conveyor 203 receives a command from a control device (not shown) such as a computer and drives the motor, and conveys a tray. The third conveyor 203 is located downstream of the medication supplying unit 103, and delivers a tray 107 on which a medication is placed to a conveyor provided at lower portions of the printer unit 104 and the accommodated tray unit 105.

(3, Supplying Means)

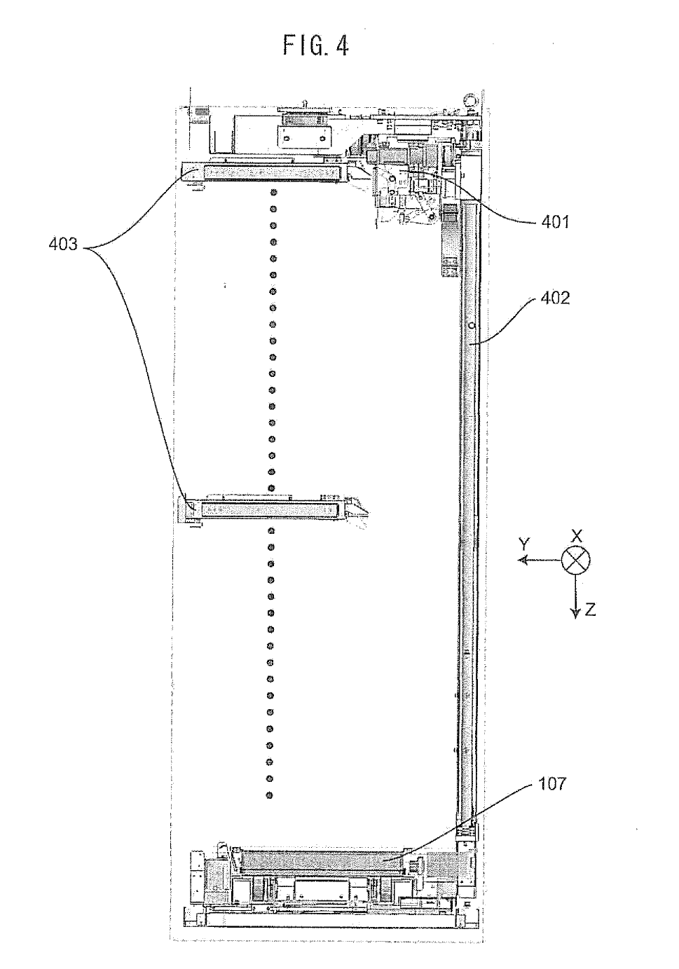

Details of the supplying means in the medication supplying unit of the automatic medication dispensing device of the invention will be described using FIGS. 4 to 6.

FIG. 4 is a side view of an interior of the medication supplying unit of the automatic medication dispensing device. In FIG. 4, a deep side vertical direction on the sheet is X direction, a downward direction of the sheet is Z direction, and a leftward direction is Y direction. The medication supplying unit includes a head section 401 which takes out a medication from the medication storing case and conveys the medication to a tray 107, a head conveying section 402 which conveys a medication by moving the head section 401 in XZ direction, and a plurality of medication storing cases 403 which store medications by kinds.

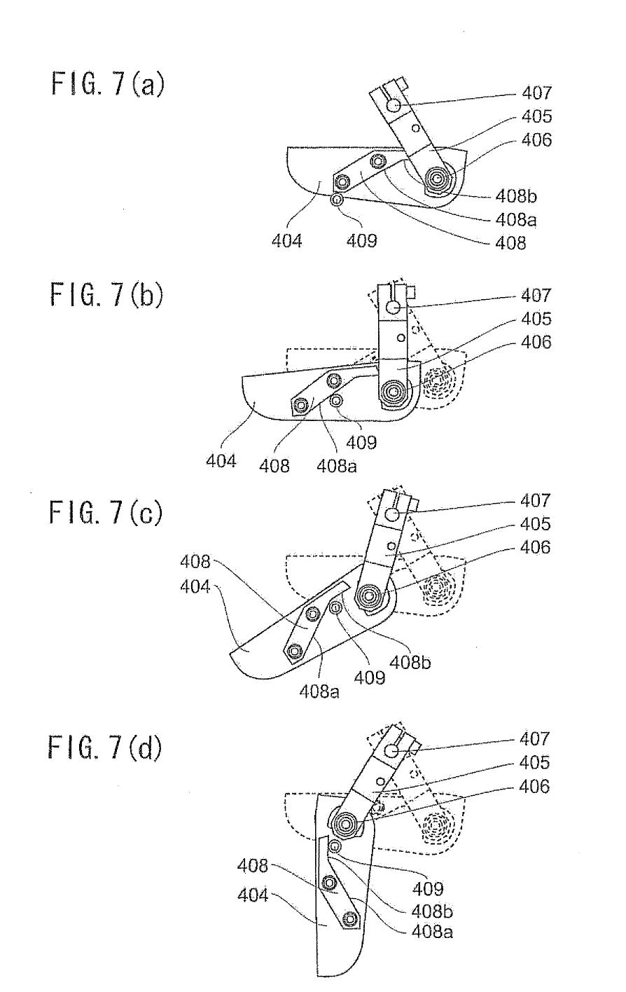

The head section 401 is moved to the medication storing case 403 which stores a desired medication by the head conveying section 402 based on the prescription instruction from a computer (not shown), receives the medication, and is again moved to a location directly above a tray 107 by the head conveying section 402, and places the medication on the tray 107, i.e., dispenses the medication. When the medication is dispensed, a pocket 404 of the head section 401 has such a configuration that pocket 404 moves forward toward the tray 107 as will be described later with reference to FIG. 7. Therefore, a space in which the head section 401 rides on the head conveying section 402 and moves can be made small, the medication storing cases 403 can be extended rearward correspondingly and therefore, more medications can be stored. A configuration of the head section 401 will be described based on the following embodiments.

### First Embodiment

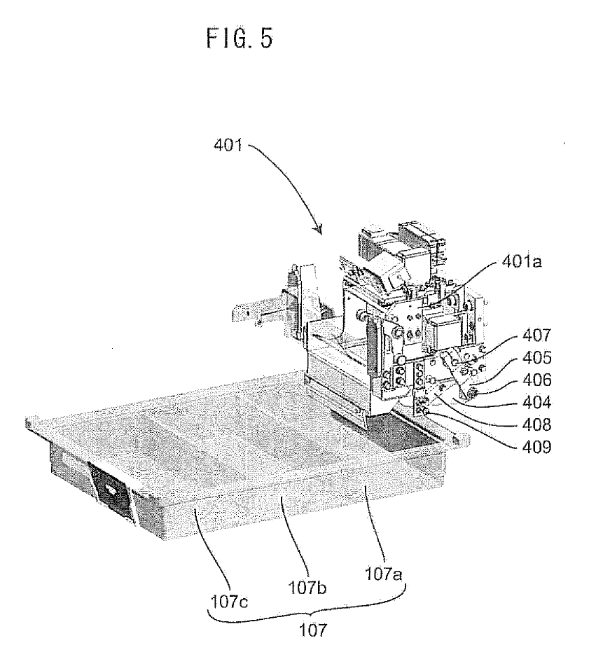

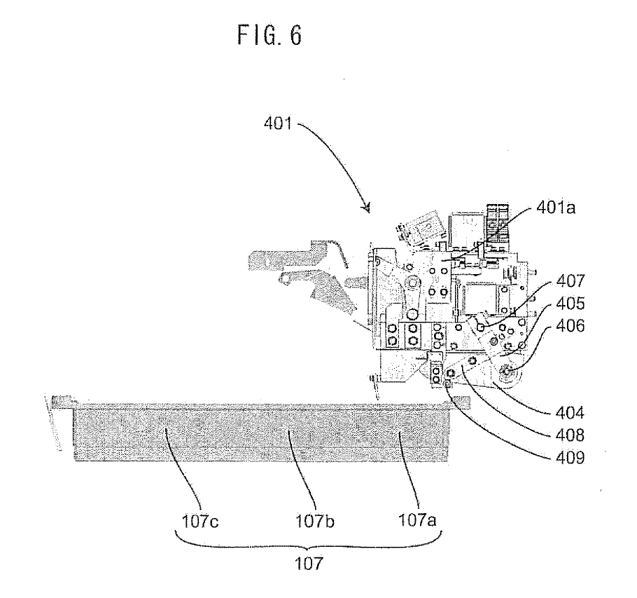

FIGS. 5 and 6 are perspective view and a side view of an outward appearance of the head section 401 which is the supplying means of a first embodiment.

The head section 401 is provided with a head section body 401a. The head section body 401a includes the pocket 404, an arm 405, a first shaft 406, a second shaft 407, a guide 408 and a roller 409.

The head section body 401a is a head body section, and the head section body 401a has various mechanisms for taking out a medication from the medication storing cases 403 and supplying the medication to a tray.

The pocket 404 is a pocket section, the pocket 404 temporarily holds a medication received from an upper left front of the head section 401, opens at a location directly above a tray 107 to move toward a lower left side in the drawing, and places a medication on the tray 107 on the supplying side (left end of the pocket 404 in the drawing) of the pocket 404. An inner surface of the pocket 404 is curved so that a plurality of medications can be accommodated and held. Preferably, the inner surface of the pocket 404 is provided with a cushioning such as a cloth or an elastic body such as rubber to prevent the medication container from being damaged. The pocket has any shape only if the pocket can temporarily hold a medication and can place the medication on a tray. For example, the pocket may have a cylindrical cross section.

The arm 405 is an arm section, and the arm 405 couples the head section body 401a and the pocket 404 with each other. The pocket 404 is turnably connected to one end of the arm 405 through the first shaft 406, and the head section body 401a is turnably connected to the other end of the arm 405 through the second shaft 407. The second shaft is rotated by driving means (not shown). In this embodiment, the driving means is not connected to the first shaft, and the first shaft can freely rotate.

The guide 408 is a guide section, and is provided on a side surface of the pocket 404. A guide surface of the guide 408 abuts against the roller 409, the guide 408 moves such that it slides on the roller 409, thereby moving the pocket 404 and opening and closing the pocket 404. That is, locus, opening and closing movements and timing of the pocket 404 depend on a shape of the guide 408. In this embodiment, a surface which is in contact with the roller 409 includes a first guide surface 408a and a second guide surface 408b. The first guide surface 408a mainly realizes a forward movement of the pocket 404 toward a tray, and the first guide surface 408a comes into contact with the roller 409 until the first shaft 406 reaches the lowest point. An angle of the second guide surface 408b is smaller than that of the first guide surface 408a, and mainly realizes opening movement of the pocket 404. The second, guide surface 408b comes into contact with the roller 409 after the first shaft 406 starts moving upward from the lowest point. The first guide surface 408a and the second guide surface 408b are connected to each other through a gentle curved surface such that inclinations of tangents are continued. According to this configuration, it is possible to realize smooth opening and closing movements of the pocket 404.

The roller 409 is an abutment section, and projects downward front the head section body 401a. The roller 409 is provided closer to a tray than the first shaft 406, i.e., in a positive direction from the first shaft 406 along the Y axis in the drawing. In this direction, the pocket 404 moves forward.

A tray 107 waits for a medication to be supplied by the supplying device. FIGS. 5 and 6 show that a tray 107 waits for a medication is supplied to a region 107a. This position may be a position where the tray 107 is conveyed on the second conveyor 202, or may be a position moved by the moving means perpendicularly to the conveying direction of the tray 107.

Movements of the head section 401 having the above-described configuration will be described using FIG. 7.

FIG. 7 show opening and closing movements of the pocket 404. A series of the movements is realized by applying a driving force to the second shaft 407 by driving means (not shown) such as a motor.

FIG. 7(a) shows a state where the pocket 404 is accommodated in the head section body 401a, i.e., a state where the pocket 404 is closed. At that time, a bottom surface of the pocket 404 is directed horizontal, or directed slightly upward toward a supplying opening so that a held medication does not drop. FIGS. 7(a) to 7(d) show, with broken lines, the state shown in FIG. 7(a).

FIG. 7(b) shows a state immediately before the pocket 404 starts opening. As shown with solid lines in FIG. 7(b), if the arm 405 is turned by the second shaft 407, the arm 405 is swung forward and with this, the pocket 404 moves forward toward a tray (leftward in the drawing). At the same time, the first shaft 406 of the arm 405 moves downward and the pocket 404 moves downward. Therefore, on the whole, it appears that the pocket moves in a left lower direction. However, in this state, a bottom surface of the pocket 404 still remains horizontally. If this state is viewed from the guide, the pocket 404 moves in the left lower direction toward a tray such that the first guide surface 408a of the guide 408 slides on the roller 409. According to this, since the pocket 404 has moved toward the tray, it is unnecessary to move the tray 107 toward the head section 401 using the moving means, or even if the tray 107 is moved toward the head section 401, the moving distance becomes shorter. Since the pocket 404 has also moved downward, it is possible to supply a medication at a gentler angle as compared with the conventional technique.

FIG. 7(c) shows a state when the pocket 404 opens and a medication is to be supplied. As shown with solid lines in FIG. 7(c), the roller 409 is located at a boundary between the first guide surface 408a and the second guide surface 408b. The second guide surface 408b is provided at an angle close to horizontal as compared with the first guide surface 408a. The pocket 404 it supported by the roller 409 and the first shaft 406 and in this state, as the first shaft 406 again moves upward from the lowest point, an angle formed between the first shaft 406 and the roller 409 abruptly increases, and a supplying inlet side of the pocket 404 gradually sinks. That is, the pocket 404 starts opening, and the bottom surface of the tray 107 and the supplying opening of the pocket 404 come into contact with each other. Since the pocket 404 once sinks and then starts opening in this manner, a medication is supplied at a height from the tray 107 lower than that of the conventional technique, that is, a medication can be supplied dispensed at an angle gentler than that of the conventional technique. Therefore, an impact applied to a medication can be reduced and it is possible to prevent the medication from being damaged. Since the pocket 404 starts opening in a state where it moves forward, it is unnecessary to move the tray 107 toward the head, or even if the tray 107 is moved, its moving distance can be minimized.

FIG. 7(d) shows a state where the pocket is fully opened. At that time, a position of the roller 409 is on the second guide surface 408b as shown with solid lines in FIG. 7(d). Since the first shaft 406 is moved further upward and lifts the pocket 404, the pocket 404 fully opens as shown in the drawing, and the bottom surface of the pocket 404 is directed substantially vertically. According to this, a medication does not remain in the pocket 404 and it is possible to reliably dispense the medication. If control is performed such that the entire head section 401 is brought upward, it is possible to dispense a medication from the pocket 404 to a tray 107 more reliably.

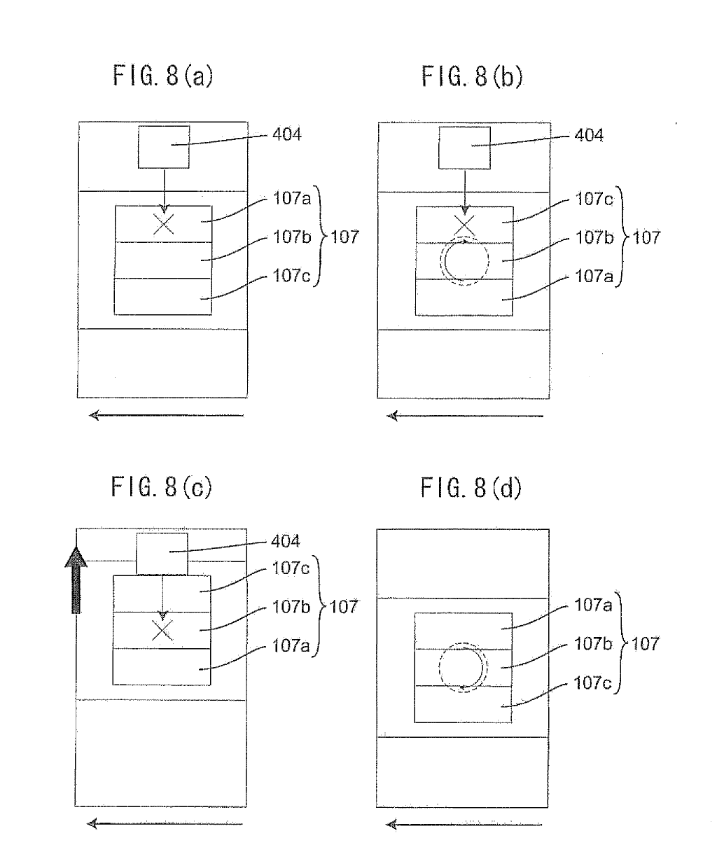

FIG. 8 show movements of a tray when a medication is dispensed to the tray and a dispensing position of the medication on the tray. In the drawings, “X” shows a position where the pocket of the head dispenses the medication.

A accommodating section of the tray 107 is divided by two partition plates into three sections, i.e., accommodating sections 107a, 107b and 107c.

First, as shown in FIG. 8(a), the pocket 404 moves forward from above in the drawing and a medication is placed on the accommodating section 107a of the tray 107 on a conveying path. As described above, since the pocket 404 moves such that its supplying opening moves forward, it is unnecessary to move the tray 107 toward the pocket 404 when a medication is placed on the accommodating section 107a.

Next, as shown in FIG. 8(b), the tray 107 is rotated by the turning means. The pocket 404 moves forward from above in the drawing and the medication is placed on the accommodating section 107c. In this case also, it is unnecessary to move the tray 107 toward the pocket 404.

As shown in FIG. 8(c), the tray 107 is moved toward the pocket 404 by the moving means. The pocket 404 moves forward and a medication is placed on the accommodating section 107b. Since the pocket 404 can move forward and the medication can be dispensed to the tray 107, the distance through which the tray 107 is moved by the moving means can be shortened, and a depth dimension of the device can be shortened. It is necessary that a moving space for the head section 401 in the Y axis direction (see FIG. 4) is provided only directly above the tray 107, it is possible to extend the depth dimension of the medication storing case and it is possible to store more medicines in a limited space.

Lastly, as shown in FIG. 8(d), the tray is returned to the original tray conveying path by the moving means and the orientation of the tray 107 is returned to its original orientation.

When medications are placed on the accommodating sections 107a and 107c, the medications are received on the conveying path, but it is also possible to move the tray in a direction perpendicular to the conveying path by the moving means.

By employing such a configuration, since the pocket and the tray come close to each other, the movement of the tray in the direction perpendicular to the tray conveying path can be suppressed to the minimum value, and it is possible to shorten the depth dimension of the medication dispensing device. More Specifically, in this embodiment, since the pocket 404 comes close by 50 mm and the tray 107 comes close by 150 mm, the device itself can be thinned by 50 mm.

### Second Embodiment

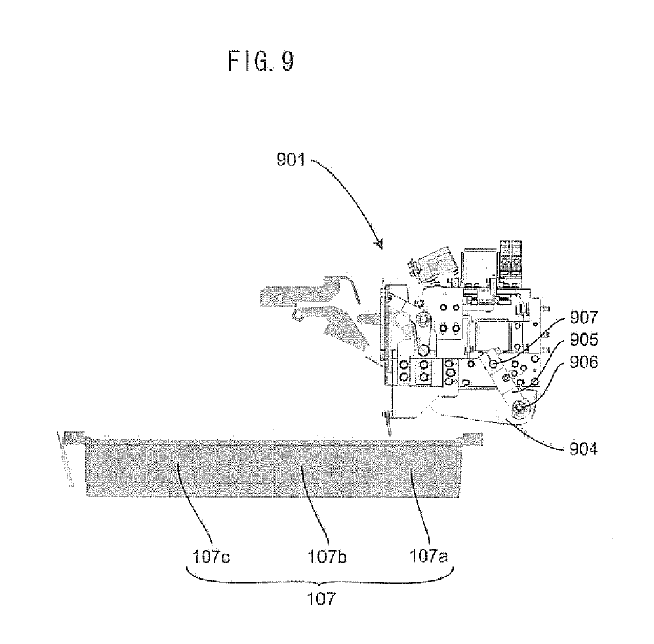

FIG. 9 is a side view of a head 901 which is supplying means of a second embodiment. Unlike the first embodiment, the guide section and the abutment section are not provided. Only the second shaft 407 is driven in the first embodiment, but a first shaft 906 is also driven in addition to the second shaft in the second embodiment. That is, the first shaft 906 and a second shaft 907 are connected to driving means (not shown) and rotate a pocket 904 and an arm 905.

Both the second shaft 907 and the first shaft 906 are driven in this manner, it is possible to freely control a forward moving amount of the pocket 904 and an angle of the pocket 904, and it is possible to realize the same operation as that of the first embodiment. Further, it is also possible to realize more complicated operation than that of the first embodiment. The operation will be described below.

First, the arm 905 is rotated by the driving means connected to the second shaft 907 until the arm 905 is oriented perpendicular to a bottom surface of a tray. At that time, the driving means connected to the first shaft 906 is brought into synchronization with the driving means connected to the second shaft 907, and they rotate at the same speed. According to this, the pocket 904 can be maintained horizontally until the arm 905 reaches the lowest point.

After the arm 905 exceeds the lowest point, the rotation speed of the first shaft is gradually increased. According to this, the supplying opening side (left end of the pocket) of the pocket 904 starts lowering.

After a supplying opening side of the pocket 904 comes into contact with the bottom surface of the tray 107, the head 901 is brought upward. According to this, the pocket 904 is fully opened and a medication can reliably be supplied to the tray.

In this embodiment also, since the supplying point of a medication can be set forward as compared with the conventional technique, the moving amount of the tray is reduced, it is possible to realize a thinner medication dispensing device. Since the supplying point of the medication can be set lower as compared with the conventional technique, it is possible to supply a medication to a tray using the method in which an impact applied to the medication is small.

### Third Embodiment

A third and subsequent embodiments are not for preventing damage of the medication container generated when a medication is dispensed from the supplying means to a tray, but are for supplying means to prevent damage of a medication container generated between instant when the supplying means takes out a medication from a medication storing case and instant when the medication reaches a pocket of the supplying means.

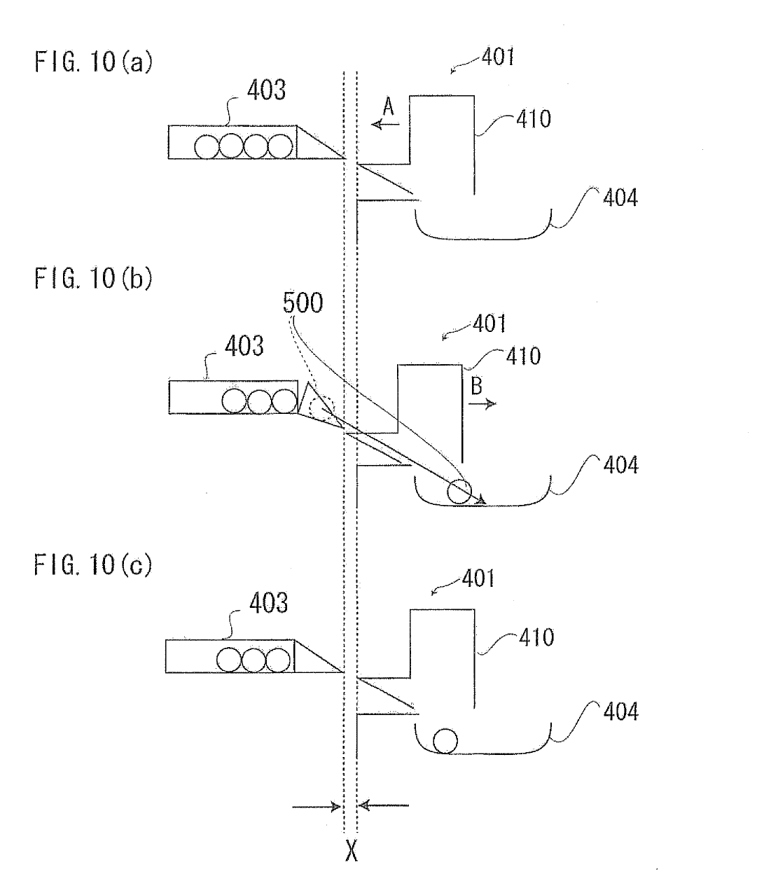

FIG. 10 are schematic diagrams showing, in stages, medication taking out movements in the automatic medication dispensing device. This automatic meditation dispensing device does not include a flap having a limited installation space, especially a limited depth dimension. As shown in FIG. 10(a) to (c), the head section 401 has a pocket 404 and a chute 410. The chute 410 functions as a path of a medication 500 when the medication 500 in the medication storing case 403 is taken out into the head section 401.

As shown in FIG. 10(a), when the medication 500 in the meditation storing case 403 is taken out, the chute 410 of the head section 401 moves toward the medication storing case 403 (direction of arrow A). Then, the medication 500 in the medication storing case 403 is made to drop into the pocket 404 through the chute 410 and is taken out as shown in FIG. 10(b). Thereafter, the chute 410 moves in a direction separating away from the medication storing case 403 (direction of arrow B). As shown in FIG. 10(c), the chute 410 returns to its original position (same position as that shown in FIG. 10(a)) and the taking out operation of the medication 500 from the medication storing case 403 by the head section 401 is completed.

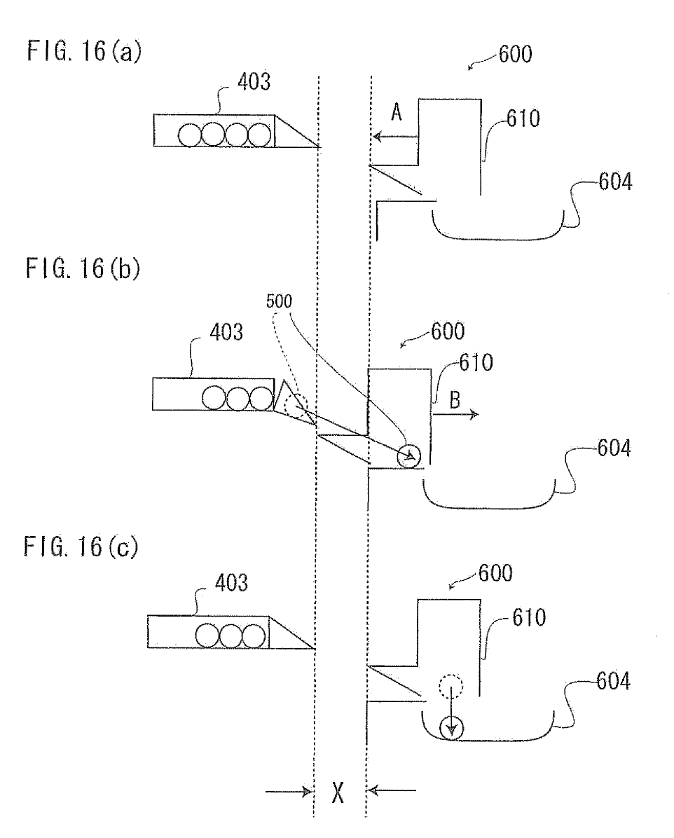

According to a conventional medication supplying unit 600 shown in FIG. 16, a medication 500 is temporarily stopped in a chute 610 as shown in FIG. 16(b) by sufficiently securing a moving distance X of the chute 610, speed of, the medication 500 generated when it drops into the chute 610 from the medication storing case 403 is absorbed and then, the medication 500 is taken out from the chute 610 into the pocket 604 as shown in FIG. 16(c). In the automatic medication dispensing device 101 having the limited depth dimension, however, when a medication 500 is taken out from the medication storing case 403, since the moving distance X of the chute 410 is limited, the medication 500 can not be absorbed in the chute 410. As a result, the medication 500 drops directly into the pocket 404 of the head section 401 from the medication storing case 403 (see FIG. 10(b)). Therefore, since dropping speed of the medication 500 into the pocket 404 corresponds to a height of the medication storing case 403 from the pocket 404, when a plurality of medications 500 are taken out into the pocket 404, the medications 500 collide against each other and there is fear that a problem that the medications 500 become cracked.

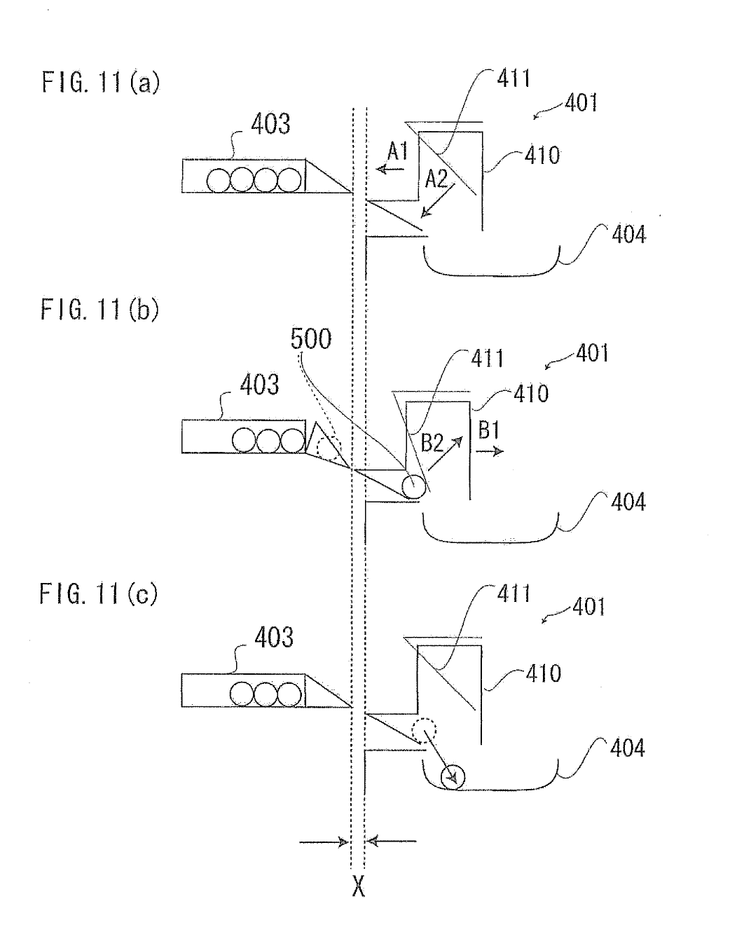

To prevent this problem from (generating, the head section 401 of the third embodiment is provided with a flap 411 which temporarily stops a medication 500 when it is taken out from the medication storing case 403 to the head section 401 as shown in FIG. 11. The flap 411 temporarily stops a medication 500 when it is taken out from the medication storing case 403 to the head section 401 based on the prescription instruction, and after the medication 500 is temporarily stopped, the medication 500 is moved in a direction in which engagement with the medication 500 is released, thereby releasing the engagement with the medication 500 and the medication 500 is made to drop into the pocket 404.

FIG. 11 are schematic diagrams showing, in stages, medicine taking out movements of the automatic medication dispensing device of the third embodiment of the device. As shown in FIG. 11(a), when a medication 500 in the medication storing case 403 is taken out, the chute 410 of the head section 401 moves in a direction approaching the medication storing case 403 (direction of arrow A1), and the flap 411 moves in a direction approaching the path for the medication 500 in the chute 410 (direction of arrow A2). More specifically, the flap 411 moves in a direction in which the flap 411 is pushed against the chute 410 in an interlocking manner with a mechanism which opens a rear gate (not shown) of the medication storing case 403 located on the head section 401 when the head section 401 approaches the medication storing case 403. Since the flap 411 is made to stand utilizing the mechanism which opens the rear gate of the medication storing case 403 of the head section 401 in this manner, it is possible to excellently bring the movement of the head section 401 and the movement of the flap 411 into synchronization with each other. Then, as shown in FIG. 11(b), the medication 500 which was taken out from the medication storing case 403 by the flap 411 is temporarily stopped in the chute 410, thereby absorbing the speed of the medication 500.

After the medication 500 is temporarily stopped in the chute 410, the chute 410 is moved to a direction (direction of arrow B1) returning to its original position (see FIG. 11(a)) when the chute 410 is moved, the flap 411 is also moved to a direction (direction of arrow B2) returning to its original position (see FIG. 11(a)). More specifically, in a state where the head section 401 is separated away from the medication storing case 903, the flap 411 is in a state where it is biased by a spring and separated away from the chute 410. That is, if the head section 401 is brought into the state where it is separated away from the medication storing case 403, the flap 411 is automatically moved in the direction in which it is biased by a spring provided on a later-described hinge 412 and the flap 411 is opened. If the flap 411 is moved to jump up in the direction of arrow B2, the engagement between the flap 411 and the medication 500 is released as shown in FIG. 11(c), and the medication 500 can reliably be made to drop into the pocket 404.

A medication 500 is temporarily stopped in the chute 410 in this manner. According to this the speed of the medication 500 which drops into the pocket 404 of the head section 401 can be reduced. Therefore, when a plurality of medications 500 are to be taken out into the pocket 404, it is possible to avoid a case where the medications 500 collide against each other and they are damaged.

If the flap 411 automatically moves in accordance with movement of the chute 410, it is possible to reliably drop, into the pocket 404, a medication 500 which was temporarily held in the chute 410 when the medication 500 is dispensed. Hence, it is possible to reliably avoid such an error that a taken out medication 500 can hot open the flap by its own weight and does not drop into the supplying means and the medication 500 is not dispensed, and such an error that a medication which did not drop is dispensed when another medication for other patient is dispensed.

Although the flap 411 is moved through the hinge 412 which is biased by the spring (not shown) in synchronization with the movement of the chute 410 in this embodiment, the flap 411 may be moved in synchronization with movement of the entire head section 401 of course. Alternatively, it is possible to employ such a configuration that the flap is always biased toward the medication storing case 403 through a resilient member such as a spring via the hinge 412, and when the head section 401 is disengaged from the medication storing case 403, the flap 411 is moved to jump up the flap 411. At that time after sufficient time during which a medication 500 drops into the pocket 404 is elapsed, the flap 411 may be moved toward the medication storing case 403.

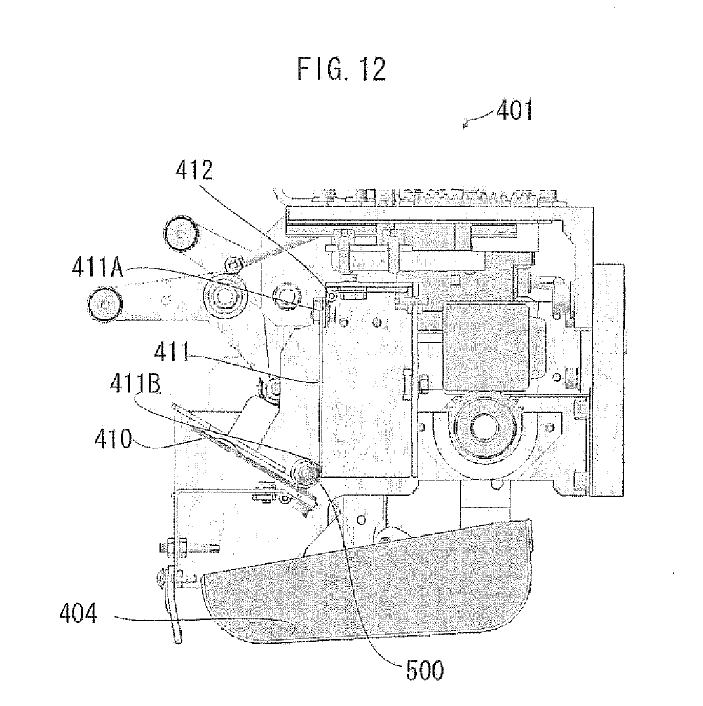

FIG. 12 is a side view showing a state where one of side surfaces is removed for explaining an interior structure of the head section 401. FIG. 12 shows a state where the medication 500 shown in FIG. 11(b) is temporarily stopped in the chute 410. As shown in FIG. 12, if the flap 411 is held at a predetermined position, the medication 500 can temporarily be stopped on the chute 410. If the flap 411 is moved such that an end 411B of a lower side of the flap 411 jumps up, engagement between the flap 411 and the medication 500 can be released and the medication 500 can drop into the pocket 404.

The flap 411 in the third embodiment is hinged to the head section 401 by the hinge 412 as holding means in an upper end 411A which is opposite from an end 411B of the flap 411. Hence, the flap 411 can turn around a portion thereof which is hinged on the head section 401 by the hinge 412.

The flap 411 of the third embodiment is held by the hinge 412 at a position where a medication 500 is temporarily stopped in the chute 410 or at a position where engagement between the flap 411 and the medication 500 is released and the medication 500 can drop into the pocket 404 in accordance with a stage of the taking out operation of the medication 500. Means for driving the flap 411 may be integrally formed with the hinge 412, or may be formed as an independent member.

As described above, according to the automatic medication dispensing device of the third embodiment, the taking out speed of a medication into the supplying means can sufficiently be reduced. Therefore, when a plurality of medications 500 are to be taken out into the supplying means, it is possible to avoid a case where the medications collide against each other and they are damaged.

In the dispensing operation of a medication, it is possible to reliably avoid such an error that a taken out medication can not open the flap by its own weight and does not drop into the supplying means and the medication is not dispensed, and such an error that a medication which did not drop is dispensed when another medication for other patient is dispensed.

### Fourth Embodiment

The head section 401 having the flap 411 is described in the third embodiment, but in a fourth embodiment, an automatic medication dispensing device 101 having a movable section 413 in addition to the flap 411 will be described. Since an entire configuration of the automatic medication dispensing device is the same as that of the third embodiment, explanation thereof will be omitted. Members having the same functions as those described above are designated with the same numbers and explanation thereof will, be omitted.

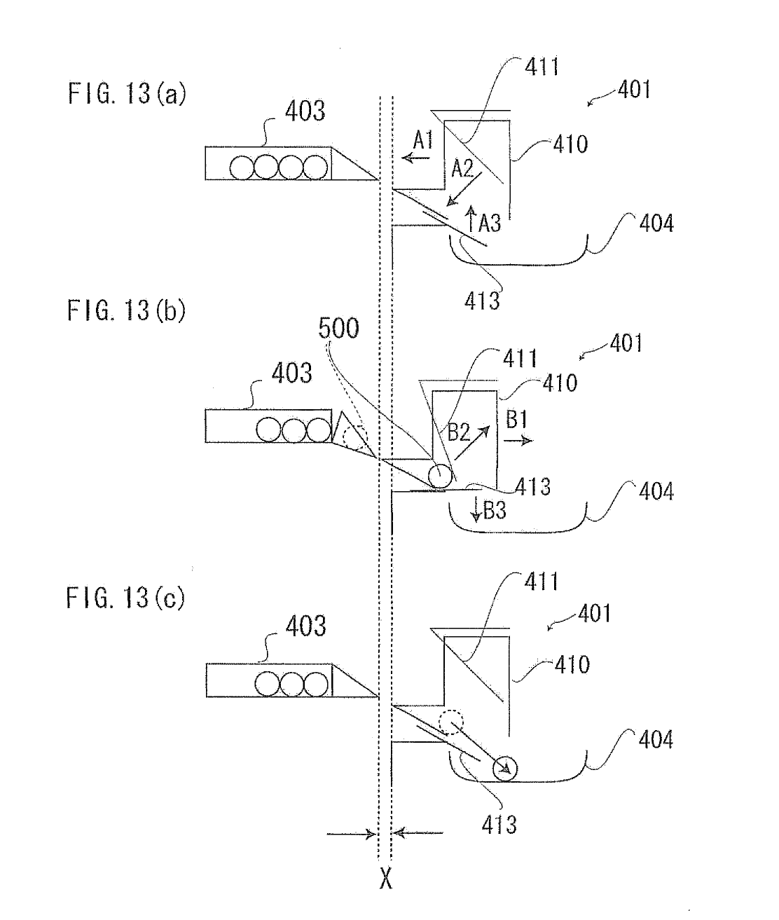

FIG. 13 are schematic diagram showing, in stages, medication taking out movements of the automatic medication dispensing device of the fourth embodiment of the invention. As shown in FIG. 13(a), when a medication 500 in the medication storing case 403 is taken out, the chute 410 moves in a direction (direction of arrow A1) approaching the medication storing case 403, the flap 411 moves in a direction (direction of arrow A2) approaching a path for the medication 500 in the chute 410, and the movable section 413 moves upward (direction of arrow A3).

As shown in FIG. 13(b), a medication 500 taken out from the medication storing case 403 is temporarily stopped by the flap 411 and the movable section 413, thereby absorbing its speed. Since all of the chute 410, the flap 411 and the movable section 413 return to their original positions (FIG. 13(a)) after a medication 500 is temporarily stopped, they move in the directions shown with the arrow B1, B2 and 53. By this movement, the engagement between the flap 411, the movable section 413 and the medication 500 is released, and the medication 500 can drop into the packet 404.

By temporarily stopping the medication 500 in the chute 410, the dropping speed of the medication 500 into the pocket 404 of the head section 401 can be reduced. Therefore, when a plurality of medications 500 are to be taken out into the pocket 404, it is possible to avoid a case where the medications collide against each other and they are damaged.

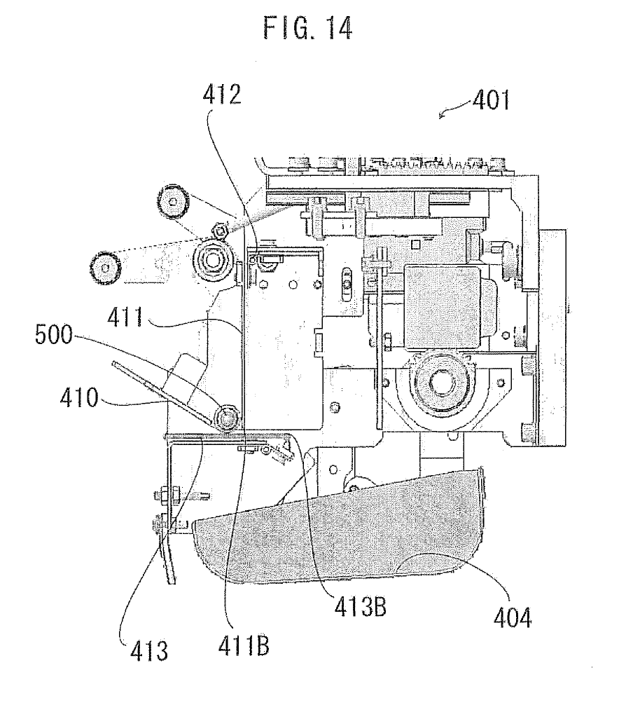

Positions of the flap 411 and the movable section 413 are changed in accordance with the movement of the chute 410, that is, an inclination angle of the movable section 413 is changed in an interlocking manner with movement of the flap 411. Here, the inclination angle of the movable section 413 is an angle formed between a horizontal surface and a straight line which connects a portion of the movable section 413 where a medication 500 is temporarily stopped and an end 413B (see FIG. 14) of the movable section 413 with each other. For example, in a state where a medication 500 is temporarily stopped in the chute 410, a surface of the movable section 413 is oriented horizontally, i.e., an inclination angle of the movable section 413 is set to 0°, and the surface of the movable section 413 is inclined such that its end 413B is moved downward in an interlocking manner with the movement of the flap 411. According to this, in the dispensing operation of the medication 500, it is possible to reliably drop, into the pocket 404, a medication 500 which is temporarily held in the chute 410. Therefore, it is possible to reliably avoid such an error that a taken out medication 500 can not open the flap by its own weight and does not drop into the supplying means and the medication is not dispensed, and such an error that a medication which did not drop is dispensed when another medication for other patient is dispensed.

It is possible to employ such a configuration that the inclination angle of the movable section 413 is set to 0° in a state where a medication 500 is temporarily stopped in the chute 410 and is set to 30° in an interlocking manner with the movement of the flap 411, but the inclination angle is not limited to this and the inclination angle can appropriately be set.

A fact that the inclination angle of the movable section 413 is changed in the interlocking manner with the movement of the flap 411 means that the inclination angle of the movable section 413 is changed while a medication 500 which is temporarily held in the chute 410 by the flap 411 exists on the movable section 413. Therefore, the invention is not limited to a configuration that the inclination angle of the movable section 413 is changed simultaneously with the movement of the flap 411, and it is possible to employ a configuration that the flap 411 moves after the inclination angle of the movable section 413 is changed, or a configuration that the flap 411 moves before the inclination angle of the movable section 413 is changed.

FIG. 14 is a side view showing a state where one of side surfaces is removed for explaining an interior structure of the head section 401. FIG. 14 shows a state where a medication 500 shown in FIG. 13(b) is temporarily stopped in, the chute 410. As shown in FIG. 14, it is possible to temporarily stop the medication 500 by holding the flap 411 and the movable section 413 at predetermined positions. From the state shown in FIG. 14, if the flap 411 is moved to jump up the lower end 411B of the flap 411 and the movable section 413 is moved such that the end 413B on the side where the movable section 413 passes when the medication 500 drops into the pocket 404, the engagement between the flap 411, the movable section 413 and the medication 500 can be released, and it is possible to reliably drop the medication 500 into the pocket 404.

The movable section 413 of the fourth embodiment is a plate body on which a medication 500 can be placed. The end 413B is movable in the vertical direction such that the end 413B on the side where the movable section 413 passes when the medication 500 drops into the pocket 404 comes lower than a portion thereof where the medication 500 is placed.

As described above, according to the automatic medication dispensing device 101 of the fourth embodiment, the path through which a medication 500 is taken out from the medication storing case 403 to the head section 401 is provided with the movable section 413, and the end 413B of the movable section 413 moves downward in the interlocking manner with the movement of the flap 411. That is, the automatic medication dispensing device of this embodiment includes the movable section which swings together with the flap as means for stopping a medication, and the speed of a medication when it is taken out to the supplying means can sufficiently be reduced. Therefore, when a plurality of medications is to be taken out into the supplying means, it is possible to avoid a case where the medications collide against each other and they are damaged.

Further, in the dispensing operation of medications, it is possible to reliably avoid such an error that a taken out medication can not open the flap by its own weight and does not drop into the supplying means and the medication is not dispensed, and such an error that a medication which did not drop is dispensed when another medication for other patient is dispensed.

### Fifth Embodiment

In the third and fourth embodiments, it is described that when a medication is taken out, the medication is temporarily stopped and the speed of the medication is once brought to zero. In a fifth embodiment, the medication is not temporarily stopped when it is taken out, and the dropping speed of the medication into the supplying means is reduced to prevent, the medication from being damaged. This configuration will be described below. Since the entire structure of the automatic medication dispensing device has been already explained, explanation thereof will be omitted. Members having the same functions as those described above are designated with the same numbers and explanation thereof will be omitted.

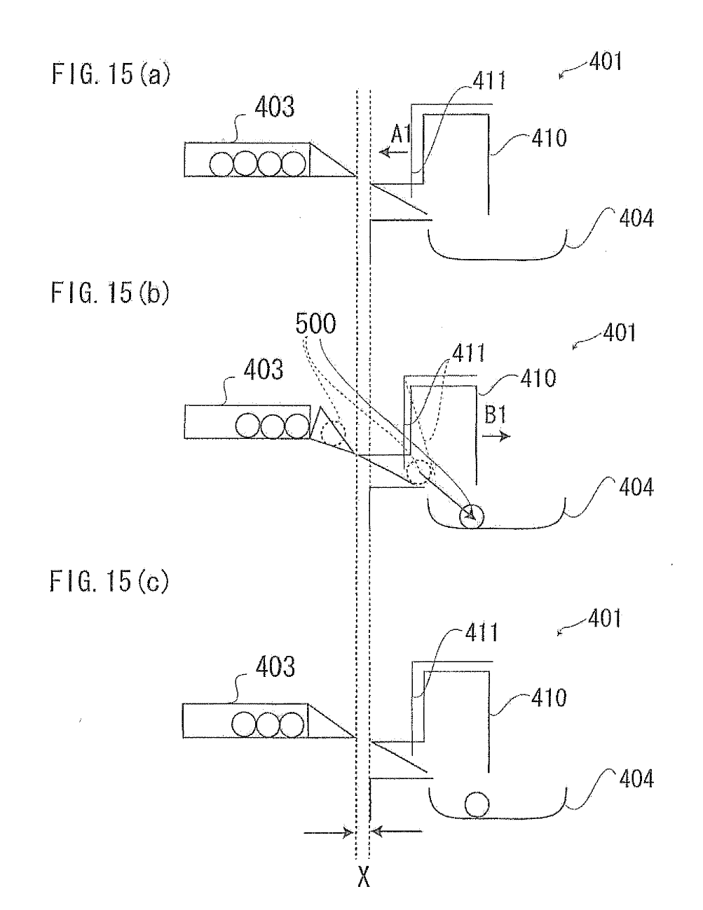

FIG. 15 are schematic diagram showing, in stages, medication taking out movements of the automatic medication dispensing device of the fifth embodiment of the invention. As shown in FIG. 15(a), when a medication 500 in the medication storing case 403 is taken out, the chute 410 moves in a direction (direction of arrow A1) approaching the medication storing case 403. The flap 411 of the fifth embodiment is hinged to the head section 401 such that its end 411B on the side of the chute 410 can freely turn. The flap 411 does not have means which drives the flap 411 to hold the end 411B at a predetermined position, but the flap 411 is provided at a position where it comes into contact with a medication 500 when the medication 500 in the medication storing case 403 is taken out to the head section 401. Hence, the medication 500 taken out from the medication storing case 403 comes into contact with the flap 411 in the chute 410, and the medication 500 moves such that its one end jumps up. At that time it is possible to reduce the speed of the medication 500 by a value corresponding to energy consumed for jumping the flap 411 up.

By providing the flap 411 at the position where it comes into contact with a medication 500, the dropping speed of the medication 500 into the pocket 404 of the head section 401 can be reduced. Therefore, when a plurality of medications 500 are to be taken out into the pocket 404, it is possible to avoid a case where the medications collide against each other and they are damaged.

By appropriately adjusting size, weight and resistance against turning motion of the flap 411 in accordance with weight of a medication 500, it is possible to reliably avoid such an error that a taken out medication 500 can not open the flap by its own weight and does not drop into the supplying means and the medication is not dispensed, and such an error that a medication which did not drop is dispensed when another meditation for other patient is dispensed.

### INDUSTRIAL APPLICABILITY

The present invention can be utilized as the automatic medication dispensing device in a hospital and in addition, the invention can also be utilized as a device which accommodates various kinds of articles in a fractionation manner in accordance with predetermined information.

1. An automatic medication dispensing device having supplying means which supplies accommodated medications to a tray based on the prescription instruction, wherein
the supplying means includes
a head body section,
a pocket section which temporarily holds a taken out medication and which places the medication on the tray, and
an arm section which couples the head body section and the pocket section to each other,
the pocket section is turnably connected to one end of the arm section through a first shaft, and the other end of the arm section and the head body section are turnably connected to each other through a second shaft.

2. The automatic medication dispensing device according to claim 1, wherein
an abutment section is provided at a position of the head body section closer to the tray than the first shaft,
the pocket section is provided with a guide section,
the guide section abuts against the abutment section and in this state, the pocket section places a medication on the tray.

3. The automatic medication dispensing device according to claim 2, wherein the guide section includes a first guide surface and a second guide surface which is continuous with the first guide surface and which has a curvature or an angle different from that of the first guide surface.

4. The automatic medication dispensing device according to claim 3, further comprising tray conveying means which conveys the tray, wherein
the tray conveying means includes moving means which moves the tray toward the pocket section when a medication is placed on the tray.

5. The automatic medication dispensing device according to claim 1, further comprising tray conveying means which conveys the tray, wherein
the tray conveying means includes turning means which rotates the tray in a horizontal direction.

6. An automatic medication dispensing device including supplying means which temporarily holds medications accommodated in a medication storing case and then dispenses the medication to a tray based on a prescription instruction, wherein
the automatic medication dispensing device includes a flap provided at a position where the flap comes into contact with the medication when the medication is taken out from the medication storing case to the supplying means.

7. The automatic medication dispensing device according to claim 6, wherein when the medication in the medication storing case is taken out to the supplying means based on a prescription instruction, the medication is temporarily stopped by the flap, and after the medication is temporarily stopped, the flap is moved, thereby releasing engagement between the medication and the flap to drop the medication into the supplying means.

8. The automatic medication dispensing device according to claim 7, further comprising holding means which holds the flap at a position where the medication is temporarily stopped and a position where engagement with respect to the medication is released when the medication in the medication storing case is taken out to the supplying means.

9. The automatic medication dispensing device according to claim 7, further comprising a movable section at a path where the medication is taken out from the medication storing case, wherein an inclination angle of the movable section is changed in an interlocking manner with movement of the flap.

10. The automatic medication dispensing device according to claim 2, further comprising tray conveying means which conveys the tray, wherein
the tray conveying means includes turning means which rotates the tray in a horizontal direction.

11. The automatic medication dispensing device according to claim 3, further comprising tray conveying means which conveys the tray, wherein
the tray conveying means includes turning means which rotates the tray in a horizontal direction.

12. The automatic medication dispensing device according to claim 8, further comprising a movable section at a path where the medication is taken out from the medication storing case, wherein an inclination angle of the movable section is changed in an interlocking manner with movement of the flap.
